(19) United States
(12) Patent Application Publication
(10) Pub. No.: US 2025/0251499 A1
(43) Pub. Date: Aug. 7, 2025

(54) METHOD AND SYSTEM OF CALIBRATION FOR MULTI-LIDAR AND INTEGRATED-NAVIGATION

(71) Applicants: INSTITUTE OF AUTOMATION, CHINESE ACADEMY OF SCIENCE, Beijing (CN); QINGDAO WAYTOUS INTELLIGENT ROBOTICS CO., LTD., Qingdao (CN)

(72) Inventors: Bin TIAN, Beijing (CN); Junhui WANG, Beijing (CN); Long CHEN, Beijing (CN); Yunfeng AI, Qingdao (CN); Yisheng LV, Beijing (CN); Feiyue WANG, Beijing (CN); Jun FU, Beijing (CN)

(21) Appl. No.: 18/639,999

(22) Filed: Apr. 19, 2024

(30) Foreign Application Priority Data
Feb. 5, 2024 (CN) 202410162956.5

(51) Int. Cl. G01S 7/497; G01S 17/86; G06T 7/80

(52) U.S. Cl. CPC G01S 7/497; G01S 17/86; G06T 7/80; G06T 2207/10028

(57) ABSTRACT

The present invention discloses a method and system of calibration for multi-lidar and integrated-navigation, comprising: obtaining raw point cloud data from multiple lidars and integrated navigation data, and calculating an initial extrinsic parameter characterizing a conversion relationship between each lidar and said integrated navigation data; adjusting the initial extrinsic parameter and the integrated navigation data to obtain a first-type extrinsic parameter between each lidar and the integrated navigation apparatus, as well as optimized integrated navigation data; obtaining, according to the first-type extrinsic parameter, a compensation matrix for compensating a vertical component of an extrinsic parameter between each lidar and the integrated navigation apparatus; and obtaining a second-type extrinsic parameter between individual lidars according to the compensation matrix and the first-type extrinsic parameter of each lidar as well as the optimized integrated navigation data.

### TECHNICAL FIELD

The present invention relates to the technical field of autonomous driving, and specifically to a method and system of calibration for multiple lidars and integrated navigation in a vehicle.

### TECHNICAL BACKGROUND

In the technical field of surveying and mapping, two methods are generally adopted for extrinsic-parameter calibration between the laser radar (“lidar”) and the integrated navigation apparatus, namely approximation method and rigorous method. The approximation method focuses on reducing the discrepancy between lidar data in the absence of positioning data from the integrated navigation apparatus; however, the discrepancy cannot be completely eliminated. Meanwhile, the rigorous method utilizes data from the lidar and the integrated navigation apparatus for sensor calibration, while taking system calibration error into consideration.

In the technical field of autonomous driving, there have been few studies on calibration technology for lidar and integrated navigation, while hand-eye calibration method is commonly used. However, the hand-eye calibration method is not precise enough, and mostly used to provide initial values for other calibration methods. Further, an extrinsic-parameter calibration method for lidar and integrated navigation based on planar bundle adjustment has been proposed. However, this method is limited to extraction of environment plane, and thus is only applicable to rotating mechanical lidar.

There are generally two types of extrinsic-parameter calibration methods for a multi-lidar system, namely target-based methods and target-free methods. In the target-based methods, space migration is determined by integrating data from multiple sensors, wherein identifiable objects and corresponding points are required. The target-free methods can be further divided into motion-based methods and appearance-based methods, wherein the motion-based target-free methods estimate extrinsic parameters by analyzing trajectories in the local coordinate system and constructing motion constraints, while the appearance-based target-free methods rely on the appearances of objects in the observation environment to perform calibration between sensors.

To sum up, the method of geometric-feature extraction is commonly adopted in the prior arts relating to the calibration for lidar and integrated navigation. As a result, the calibration methods are only applicable to specific types of lidar, thus limiting the wide application thereof. Moreover, noise that may exist in data from the integrated navigation apparatus is not taken into consideration in many of the existing calibration methods, which may lead to less accurate estimation of extrinsic parameters. In addition, the actual application of on-line multiple lidar calibration techniques is either limited to the types of lidar or specific requirements for the environment, which impede the wide application of these calibration methods to a certain extent.

### SUMMARY OF THE INVENTION

The present invention aims to propose a method of calibration for multi-lidar and integrated navigation in a vehicle that can be applied widely without limitation, so as to effectively enhance the accuracy in the calculation of extrinsic parameters.

Aiming at the above technical problems, the embodiments of the present invention propose a method of calibration for multi-lidar and integrated navigation, which comprises steps of:
obtaining raw point cloud data from multiple lidars and integrated navigation data from an integrated navigation apparatus, and calculating an initial extrinsic parameter characterizing a conversion relationship between each lidar and said integrated navigation data;
adjusting the initial extrinsic parameter and the integrated navigation data to obtain a first-type extrinsic parameter between each lidar and the integrated navigation apparatus, as well as optimized integrated navigation data, while taking into consideration a point model on a scanned surface of real space which obeys a normal distribution, differences between lidar clock sources, and vehicle vibration;
obtaining, according to the first-type extrinsic parameter, a compensation matrix for compensating a vertical component of an extrinsic parameter between each lidar and the integrated navigation apparatus; and
obtaining a second-type extrinsic parameter between individual lidars according to the compensation matrix and the first-type extrinsic parameter of each lidar as well as the optimized integrated navigation data.

Preferably, each initial extrinsic parameter is calculated through steps of:
transforming the raw point cloud data of all lidars from a lidar coordinate system to a world coordinate system for point cloud registration, thus obtaining a local point cloud map model of each lidar, which contains the extrinsic parameter to be estimated between a respective lidar and the integrated navigation apparatus;
searching a nearest point of each point in the local point cloud map model to construct a rotation matrix between each lidar and the integrated navigation apparatus, wherein a sum of distances between point pairs, each pair consisting of a respective one of all points and the nearest point thereof, is taken as an error, and the rotation matrix is formed after the error is minimized; and
assigning a translation matrix to zero, and solving the rotation matrix between each lidar and the integrated navigation apparatus, thereby obtaining an initial rotation matrix of extrinsic parameter for each lidar, said initial rotation matrix characterizing the initial extrinsic parameter.

Preferably, the step of adjusting the initial extrinsic parameter and the integrated navigation data to obtain a first-type extrinsic parameter between each lidar and the integrated navigation apparatus, as well as optimized integrated navigation data, while taking into consideration a point model on a scanned surface of real space which obeys a normal distribution, differences between lidar clock sources, and vehicle vibration comprises:
calculating a first surface-to-surface distance between two local surfaces of the real space where any two points sampled by a same lidar are located respectively;
constructing, based on the first surface-to-surface distance, the initial rotation matrix of extrinsic parameter of each lidar and the integrated navigation data, an extrinsic-parameter rough adjustment model for roughly adjusting the extrinsic parameter between each lidar and the integrated navigation apparatus, while taking into consideration the point model on the scanned surface of the real space that obeys a normal distribution;
solving the extrinsic-parameter rough adjustment model through minimum estimation, thereby obtaining an estimated rotation matrix of extrinsic parameter of each lidar;
constructing, based on the first surface-to-surface distance, the estimated rotation matrix of extrinsic parameter of each lidar and the integrated navigation data, an extrinsic-parameter adjustment model for precisely adjusting the extrinsic parameter between each lidar and the integrated navigation apparatus, while taking into consideration the differences between the lidar clock sources and the vehicle vibration; and
solving the extrinsic-parameter adjustment model through minimum estimation, in order to obtain the first-type extrinsic parameter between each lidar and the integrated navigation apparatus, as well as an optimized integrated navigation pose.

Preferably, the step of obtaining, according to the first-type extrinsic parameter, a compensation matrix for compensating a vertical component of an extrinsic parameter between each lidar and the integrated navigation apparatus comprises:
constructing and solving a compensation matrix for aligning ground planes in the point cloud data of any two lidars according to a specified point on the surface of the real space represented in different lidar coordinate systems, wherein a preset target positioning center is taken as a reference, and the first-type extrinsic parameters of respective lidars are taken as respective degeneration extrinsic-parameters.

Preferably, the step of obtaining a second-type extrinsic parameter between individual lidars according to the compensation matrix and the first-type extrinsic parameter of each lidar as well as the optimized integrated navigation data comprises:
calculating initial poses of each lidar at all moments, based on the optimized integrated navigation pose, and the compensation matrix and the first-type extrinsic parameter of each lidar;
calculating a second surface-to-surface distance between two local surfaces of the real space where two points respectively sampled by any two lidars at any sampling moment are located respectively, or between two points sampled by a same lidar at any two sampling moments;
constructing a pose optimization model for calculating poses of each lidar at all sampling moments based on the second surface-to-surface distance and the initial poses of each lidar;
solving the pose optimization model through iterative computations to obtain poses of lidars at all moments; and
calculating an extrinsic parameter of each lidar with respect to a main lidar based on the poses of respective lidars at all moments, thereby obtaining the second-type extrinsic parameter between individual lidars.

Preferably, the local point cloud map model is expressed as follows:

$${𝕄}_{{L}_{i}} = \{ {}^{W} {p}_{{t}_{j}}^{k} = {}_{G}^{W} {T}_{{t}_{j}} {}_{{L}_{i}}^{G} T {}^{{L}_{i}} {p}_{{t}_{j}}^{k} \vert {}^{{L}_{i}} {p}_{{t}_{j}}^{k} ∈ {}^{{L}_{i}} {ℙ}_{{t}_{j}} , {t}_{j} ∈ {𝒯}_{{L}_{i}} \} ,$$

wherein [symbol] _{L}_{ᵢ} denotes the local point cloud map model, ^{L}^{ᵢ} [symbol] ₜ_{ⱼ} denotes the raw point cloud data scanned by lidar Lᵢ, [symbol] denotes a collection of time corresponding to all points, ^{L}^{ᵢ}pₜ_{ⱼ}^{k} denotes a model of the k^{th} point in ^{L}^{ᵢ} [symbol] ₜ_{ⱼ}, ^{W}pₜ_{ⱼ}^{k} denotes ^{L}^{ᵢ}pₜ_{ⱼ}^{k} represented in world coordinate system, _{G}^{W}Tₜ_{ⱼ} denotes a pose of a positioning center of the integrated navigation apparatus of a vehicle at a sampling moment tⱼ, and _{L}_{ᵢ}^{G}T denotes the first-type extrinsic parameter between the lidar Lᵢ and the integrated navigation apparatus; and
the rotation matrix is expressed as follows:

$${}_{{L}_{i}}^{G} {R}_{init} = arg {min}_{{}_{{L}_{i}}^{G} R} ( kNNError ( {𝕄}_{{L}_{i}} ) ) ,$$

wherein _{L}_{ᵢ}^{G}Rᵢₙᵢₜ denotes the rotation matrix between the lidar Lᵢ and the integrated navigation apparatus, and kNNError( ) denotes error based on map calculation.

Preferably, the first surface-to-surface distance is calculated as follows:

$$\begin{matrix}{}^{{L}_{i}} {d}_{{t}_{i} {t}_{j}}^{kl} = {}_{G}^{W} {T}_{{t}_{i}} {}_{{L}_{i}}^{G} {T}^{{L}_{i}} {p}_{{t}_{i}}^{k} - {}_{G}^{W} {T}_{{t}_{j}} {}_{{L}_{i}}^{G} {T}^{{L}_{i}} {p}_{{t}_{j}}^{l} \\ = {}_{{L}_{i}}^{W} {T}_{{t}_{i}} {}^{{L}_{i}} {p}_{{t}_{i}}^{k} - {}_{{L}_{i}}^{W} {T}_{{t}_{j}} {}^{{L}_{i}} {p}_{{t}_{j}}^{l}\end{matrix} ,$$

wherein ^{L}^{ᵢ}dₜ_{ᵢ}ₜ_{ⱼ}^{kl} denotes the first surface-to-surface distance between a local surface where the k^{th} point sampled by lidar Lᵢ at a moment tᵢ is located and a local surface where the l^{th} point sampled thereby at a moment tⱼ is located, _{L}_{ᵢ}^{G}T denotes the first-type extrinsic parameter between the lidar Lᵢ and the integrated navigation apparatus, _{G}^{W}Tₜ_{ᵢ} and _{G}^{W}Tₜ_{ⱼ} denote poses of a positioning center of the integrated navigation apparatus of a vehicle at moments tᵢ and tⱼ, respectively, ^{L}^{ᵢ}pₜ_{ᵢ}^{k} and ^{L}^{ᵢ}pₜ_{ⱼ}^{l} denote a model of the k^{th} point sampled by the lidar Lᵢ and a model of the l^{th} point sampled thereby at the moment tⱼ, respectively, and _{L}_{ᵢ}^{W}Tₜ_{ᵢ} and _{L}_{ᵢ}^{W}Tₜ_{ⱼ} denote poses of the lidar Lᵢ at the moments tᵢ and tⱼ, respectively;
the extrinsic-parameter rough adjustment model is expressed as follows:

$${}_{{L}_{i}}^{G} T = arg {min}_{{}_{{L}_{i}}^{G} T} ( {\sum }_{{t}_{i} , {t}_{j}} {\sum }_{k , l} ρ ( {‖ {}^{{L}_{i}} {d}_{{t}_{i} {t}_{j}}^{kl} ‖}_{{\sum }_{{t}_{i} {t}_{j}}^{kl}}^{2} ) + {‖ Log ( {}_{{L}_{i}}^{G} {R}^{- 1} {( {}_{{L}_{i}}^{G} R )}_{prior} ) ‖}_{{\sum }_{R}}^{2} ) ,$$

wherein _{L}_{ᵢ}^{G}T denotes the extrinsic-parameter rough adjustment model of the lidar Lᵢ, ρ( ) denotes a robust kernel function, Σₜ_{ᵢ}ₜ_{ⱼ}^{kl} denotes a covariance matrix of a first residual block, (_{L}_{ᵢ}^{G}R)ₚᵣᵢₒᵣ denotes the initial rotation matrix of extrinsic parameter between the lidar Lᵢ and the integrated navigation apparatus, _{L}_{ᵢ}^{G}R⁻¹ denotes the estimated rotation matrix of extrinsic parameter between the lidar Lᵢ to be estimated and the integrated navigation apparatus, Log( ) denotes a symbol that directly maps SO(3) space to [symbol] ³ vector space, and Σ_{R} denotes a covariance matrix of a second residual block; and
the extrinsic-parameter adjustment model is expressed as follows:

$${}_{{L}_{i}}^{G} T = arg {min}_{{𝕋}_{G} , {}_{{L}_{i}}^{G} T} ( {\sum }_{{t}_{i} , {t}_{j}} {\sum }_{k , l} ρ ( {‖ {}^{{L}_{i}} {d}_{{t}_{i} {t}_{j}}^{kl} ‖}_{{\sum }_{{t}_{i} {t}_{j}}^{kl}}^{2} ) + {\sum }_{{t}_{i}} {‖ Log ( {}_{G}^{W} {T}_{{t}_{i}}^{- 1} {( {}_{G}^{W} {T}_{{t}_{i}} )}_{prior} ) ‖}_{{\sum }_{T}}^{2} + {‖ {Log}^{′} ( {}_{{L}_{i}}^{G} {T}^{- 1} {( {}_{{L}_{i}}^{G} T )}_{prior} ) ‖}_{{\sum }_{T}}^{2} ) ,$$

wherein _{L}_{ᵢ}^{G}T denotes the extrinsic-parameter adjustment model of the lidar Lᵢ, Σₜ_{ᵢ}ₜ_{ⱼ}^{kl} denotes the covariance matrix of the first residual block, (_{G}^{W}Tₜ_{ᵢ}) prior denotes the integrated navigation data measured in real time by the integrated navigation apparatus, _{G}^{W}Tₜ_{ᵢ}⁻¹ denotes the optimized integrated navigation pose to be estimated, Σ_{T} denotes the covariance matrix of the second and third residual blocks, (_{L}_{ᵢ}^{G}T) prior denotes the estimated rotation matrix of extrinsic parameter of the lidar Lᵢ after rough adjustment, _{L}_{ᵢ}^{G}T⁻¹ denotes the first-type extrinsic parameter of the lidar Lᵢ to be estimated, and Log′ ( ) denotes the symbol that directly maps the SE(3) space to the [symbol] ⁶ vector space.

Preferably, the compensation matrix is expressed as follows:

$${}_{{L}_{i}}^{{G}_{i}} {T}^{{L}_{i}} p = {}_{{G}_{j}}^{{G}_{i}} {T}_{{L}_{j}}^{{G}_{j}} {T}^{{L}_{j}} p ,$$

wherein _{L}_{ᵢ}^{G}^{ᵢ}T and _{L}_{ⱼ}^{G}^{ⱼ}T denote the first-type extrinsic parameters, as degeneration extrinsic-parameters, of lidars Lᵢ and Lⱼ, respectively, _{G}_{ⱼ}^{G}^{ᵢ}T denotes the compensation matrix, ^{L}^{ᵢ}p and ^{L}^{ⱼ}p denote a same specified point on the surface of the real space represented in coordinate systems {Lᵢ} and {Lⱼ}, respectively; and
solving the compensation matrix comprises steps of:
transforming the compensation matrix as a point-cloud registration expression, and then decomposing each parameter in the compensation matrix into a coordinate rotation matrix parameter and a coordinate translation matrix parameter, in order to calculate corresponding coordinate rotation matrix and coordinate translation matrix by extracting a ground plane in the point cloud data of two lidars;
the point-cloud registration expression is as follows:

$${}^{{G}_{i}} p = {}_{{G}_{j}}^{{G}_{i}} {R}^{{G}_{j}} p + {}_{{G}_{j}}^{{G}_{i}} t$$

wherein ^{G}^{ᵢ}p denotes a specified point on the surface of the real space in lidar coordinate system {Gᵢ}, _{G}_{ⱼ}^{G}^{ᵢ}R denotes the coordinate rotation matrix of the specified point on the surface of the real space from lidar coordinate systems {Gⱼ} to {Gᵢ}, ^{G}^{ⱼ}p denotes the specified point on the surface of the real space in the lidar coordinate system {Gⱼ}, and _{G}_{ⱼ}^{G}^{ᵢ}t denotes the coordinate translation matrix of the specified point on the surface of the real space from the lidar coordinate systems {Gⱼ} to {Gᵢ}; and
the coordinate rotation matrix and the coordinate translation matrix are expressed as follows:

$$\{ \begin{matrix}u = \frac{{n}_{1} \times {n}_{2}}{‖ {n}_{1} \times {n}_{2} ‖} \\ θ = arc cos ( {n}_{1} \cdot {n}_{2} ) \\ R = I + {[ u ]}_{\times } sin θ + {[ u ]}_{\times }^{2} ( 1 - cos θ ) \\ t = {[ 0 , 0 , {d}_{1} - {d}_{2} ]}^{T}\end{matrix} ,$$

wherein [n₁^{T}, d₁] and [n₂^{T}, d₂] denote parameters of the ground planes where the specified point on the surface of the real space is located represented in the lidar coordinate systems {Gᵢ} and {Gⱼ}, respectively, n₁ and n₂ denote normal vectors of two ground planes respectively, d₁ and d₁ denote intercepts of the two ground planes respectively, u denotes a unit vector orthogonal to both n₁ and n₂, θ denotes an angle between n₁ and n₂, R denotes the coordinate rotation matrix, t denotes the coordinate translation matrix, I denotes identity matrix, and T denotes transposition symbol.

Preferably, the initial pose of each lidar is calculated as follows:

$${( {𝕋}_{L} )}_{init} = \{ {}_{{L}_{m}}^{W} {T}_{{t}_{i}} = {}_{{G}_{0}}^{W} {T}_{{t}_{i}} {}_{{G}_{m}}^{{G}_{0}} {T}_{{L}_{m}}^{{G}_{m}} T \vert {}_{{G}_{0}}^{W} T ∈ {𝕋}_{G} , {}_{{L}_{m}}^{{G}_{m}} T ∈ {𝕋}_{c} , {}_{{L}_{m}}^{{G}_{m}} T ∈ {𝔼}_{G} , {L}_{m} ∈ 𝕃 , {t}_{i} ∈ {𝒯}_{{L}_{m}} \} ,$$

wherein ( [symbol] _{L})ᵢₙᵢₜ denotes initial poses of all lidars, _{L}_{ₘ}^{W}Tₜ_{ᵢ} denotes the initial pose of lidar Lₘ at moment tᵢ, G₀ denotes the target positioning center, _{G}_{₀}^{W}Tₜ_{ᵢ} denotes the optimized integrated navigation pose at the moment tᵢ, _{G}_{ₘ}^{G}^{₀}T denotes the compensation matrix of the lidar Lₘ, _{L}_{ₘ}^{G}^{ₘ}T denotes a matrix of the first-type extrinsic parameter of the lidar Lₘ, [symbol] _{G} denotes a set of poses of the optimized integrated navigation apparatus, [symbol] _{c} denotes a set of the compensation matrix, [symbol] _{G} denotes a set of the first-type extrinsic parameters between the lidars and the integrated navigation apparatus, [symbol] denotes a set of the lidars, and [symbol] denotes a set of time;
the second surface-to-surface distance is calculated as follows:

$${( {d}_{{t}_{i} {t}_{j}}^{kl} )}_{mn} = {}_{{L}_{m}}^{W} {T}_{{t}_{i}} {}^{{L}_{m}} {p}_{{t}_{i}}^{k} - {}_{{L}_{n}}^{W} {T}_{{t}_{j}} {}^{{L}_{n}} {p}_{{t}_{j}}^{l}$$

wherein (dₜ_{ᵢ}ₜ_{ⱼ}^{kl})ₘₙ denotes the second surface-to-surface distance between the local surface where the k^{th} point sampled by the lidar Lₘ at the moment tᵢ is located and the local surface where the l^{th} point sampled by lidar Lₙ at moment tⱼ is located, _{L}_{ₘ}^{W}Tₜ_{ᵢ} denotes the initial poses of the lidar Lₘ at the moment tᵢ, _{L}_{ₙ}^{W}Tₜ_{ⱼ} denotes the initial poses of the lidar Lₙ at the moment tⱼ, ^{L}^{ₘ}pₜ_{ᵢ}^{k} and ^{L}^{ₙ}pₜ_{ⱼ}^{l} denote the k^{th} point sampled by the lidar Lₘ at the moment tᵢ and the l^{th} point sampled by the lidar Lₙ at the moment tⱼ, respectively;
the pose optimization model is expressed as follows:

$${𝕋}_{L} = arg {min}_{{𝕋}_{L}} ( {\sum }_{m , n} {\sum }_{{t}_{i} , {t}_{j}} {\sum }_{k , l} ρ ( {‖ {( {d}_{{t}_{i} {t}_{j}}^{kl} )}_{mn} ‖}_{{( {\sum }_{{t}_{i} {t}_{j}}^{kl} )}_{mn}}^{2} ) + {‖ {Log}^{′} ( {}_{{L}_{0}}^{W} {T}_{{t}_{0}}^{- 1} {( T )}_{identity} ) ‖}_{{\sum }_{T}}^{2} ) ,$$

wherein (Σₜ_{ᵢ}ₜ_{ⱼ}^{kl})ₘₙ denotes a covariance matrix of a first residual block, _{L}_{₀}^{W}Tₜ_{₀} denotes the pose of lidar L₀ to be estimated at a moment t₀, (T)_{identity} denotes an identity matrix formed by the initial poses of the lidar L₀, Σ_{T} denotes a covariance matrix of a second residual block, and Log′ ( ) denotes a symbol that directly maps SE(3) space to [symbol] ⁶ vector space; and
the second-type extrinsic parameter between individual lidars is calculated as follows:

$${}_{{L}_{m}}^{{L}_{0}} T = Exp ( \frac{1}{\vert {𝒯}_{sync} \vert} {\sum }_{{t}_{i}} {Log}^{′} ( {( {}_{{L}_{0}}^{W} {T}_{{t}_{i}} )}^{- 1} {}_{{L}_{m}}^{W} {T}_{{t}_{i}} ) ) ,$$

wherein _{L}_{ₘ}^{L}^{₀}T∈ [symbol] _{G} denotes the second-type extrinsic parameter between lidars L₀ and Lₘ, _{L}_{₀}^{W}Tₜ_{ᵢ} denotes an estimated pose of the lidar L₀ at the moment tᵢ, _{L}_{ₘ}^{W}Tₜ_{ᵢ} denotes a pose of the lidar Lₘ to be estimated at the moment tᵢ, Exp( ) denotes a symbol that directly maps the [symbol] ⁶ vector space to the SE(3) space, Log′ ( ) denotes the symbol that directly maps the SE(3) space to the [symbol] ⁶ vector space, and [symbol] denotes a set of timestamps that have been synchronized.

Preferably, prior to calculating the second-type extrinsic parameter between individual lidars, the method further comprises a step of removing anomalous poses from poses of respective lidars at all moments based on 3σ principle.

In another aspect, the embodiments of the present invention disclose a computer-readable storage medium, comprising a series of instructions for performing steps in the method of calibration for multi-lidar and integrated-navigation.

Furthermore, the embodiments of the present invention disclose a system of calibration for multi-lidar and integrated-navigation, comprising:
an initialization module, configured to obtain raw point cloud data from multiple lidars and integrated navigation data from an integrated navigation apparatus, and calculate an initial extrinsic parameter characterizing a conversion relationship between each lidar and the integrated navigation data;
a first-type extrinsic-parameter calibration module, configured to adjust the initial extrinsic parameter and the integrated navigation data, taking into account factors including a point model on a scanned surface of real space which obeys a normal distribution, differences between lidar clock sources and vehicle vibration, thus obtaining a first-type extrinsic parameter between each lidar and the integrated navigation apparatus, as well as optimized integrated navigation data;
a ground alignment module, configured to obtain, based on the first-type extrinsic parameter, a compensation matrix for compensating a vertical component of an extrinsic parameter between each lidar and the integrated navigation apparatus; and
a second-type extrinsic-parameter calibration module, configured to obtain a second-type extrinsic parameter between individual lidars based on the compensation matrix and the first-type extrinsic parameter of each lidar as well as the optimized integrated navigation data.

Compared with the prior arts, one or more of the embodiments in the present invention have the following advantages or advantageous effects.

The present invention discloses a method and system of calibration for multi-lidar and integrated navigation. The method and system dispense with the need for any additional inputs such as, for example, acquisition of initialization data and preparation of calibration objects, as well as pre-calibration preparations, and provide a complete and automated calibration algorithm for multi-lidar and integrated navigation that can ultimately yield extrinsic parameters between each lidar and the integrated navigation apparatus as well as between multiple lidars. Moreover, the present invention depends less on the environment and is not limited to specific types of sensor (e.g., lidar). In the present invention, the model is constructed directly based on points to optimize solution, so the specific artificial feature of the environment is not required. In the meantime, the present invention is applicable to calibration in both structured artificial environment and unstructured natural environment, and the point-based model is applicable to all types of lidars. In addition, the present invention takes into consideration the influence of uneven ground and time synchronization on the positioning precision of the integrated navigation apparatus, thereby improving the precision and accuracy of the extrinsic-parameter calibration between the lidar and the integrated navigation apparatus, with an increase of approximately 20%. Furthermore, the present invention takes into consideration the influence of time synchronization on the calibration of multiple lidars, and estimates the extrinsic parameters of lidar indirectly by estimating the poses of lidar, thus yielding more accurate estimation results without precise time synchronization between multiple lidars.

Other features and advantages of the present invention will be set forth in the description which follows, and, in part, will be apparent from the description, or may be learned from the implementation of the present invention. The objective and other advantages of the present invention may be realized and attained from the structure particularly pointed out in the description, claims and drawings.

### BRIEF DESCRIPTION OF THE DRAWINGS

The accompanying drawings are used to provide a further understanding on the present invention, and constitute a part of the description. Together with the embodiments of the present invention, the drawings are intended to explain the present invention, but not constitute any limitation to the present invention. In the drawings:

FIG. 1 shows steps of a method of calibration for multi-lidar and integrated navigation according to embodiments of the present application;

FIG. 2 is a flow diagram showing the method of calibration for multi-lidar and integrated navigation according to embodiments of the present application; and

FIG. 3 shows modules of a system of calibration for multi-lidar and integrated navigation according to embodiments of the present application.

### DETAILED DESCRIPTION OF EMBODIMENTS

The implementation mode of the present invention will be explained in detail with reference to the embodiments and the accompanying drawings, whereby it can be fully understood how to solve the technical problem by the technical means according to the present invention, implement the technical solution, and achieve the technical effects thereof. It should be noted that all the embodiments and the technical features defined therein may be combined together if there is no conflict, and the technical solutions obtained in this manner shall all fall within the scope of protection of the present invention.

In addition, the steps illustrated in the flowchart in the drawings can be performed in a computer system containing a set of computer-executable instructions. Moreover, although a logical sequence is shown in the flowchart, in some cases these steps as shown or described may be performed in an order different than that shown herein.

The terms used herein are only intended to describe detailed embodiments, rather than intended to limit exemplary embodiments. Unless otherwise specifically indicated in the context, the singular forms “a”, “an” and “the” as used herein also include the plural. It should also be understood that the terms “including” and/or “comprising” as used herein specify the stated feature, integer, step, operation, unit, and/or component, and do not exclude the presence of, or the addition of, one or more other features, integers, steps, operations, units, components, and/or combinations thereof.

Aiming at one or more of the technical problems in the above technical background, the present invention proposes a method and system of calibration for multi-lidar and integrated navigation. The method and system do not require any extra inputs or pre-calibration preparations, and are capable of providing a complete calibration algorithm for multi-lidar and integrated navigation apparatus, thereby obtaining extrinsic parameters between the multiple lidars, as well as extrinsic parameters between each lidar and the integrated navigation apparatus. The present invention depend less on the environment and does not require specific types of sensor. Meanwhile, the influence of uneven ground and time synchronization on the positioning data of the integrated navigation apparatus and the calibration of the multiple lidars is taken into consideration, so that a more accurate estimation of the extrinsic parameters between the lidars and the integrated navigation apparatus can be obtained. In addition, the poses of lidars are optimized in the present invention, thus optimizing the extrinsic parameters of the lidars indirectly. Therefore, more accurate estimation results can be obtained without precise time synchronization between multiple lidars.

### Example 1

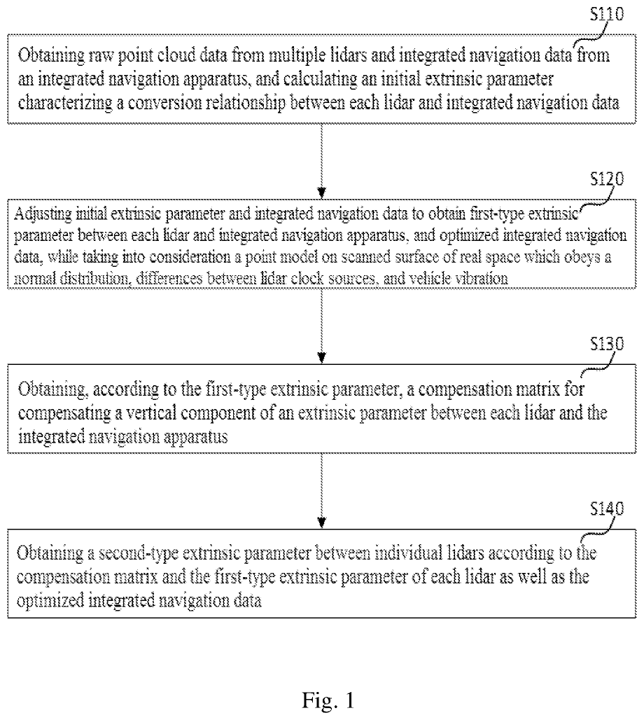

FIG. 1 shows steps of a method of calibration for multi-lidar and integrated navigation according to embodiments of the present application. The specific steps of the method of calibration for multi-lidar and integrated navigation according to embodiments of the present application (hereinafter referred to as “integrated calibration method”) are described as follows in detail with reference to FIG. 1.

In Step S110, raw point cloud data from multiple lidars and integrated navigation data from an integrated navigation apparatus during autonomous driving are obtained, based on which an initial extrinsic parameter characterizing a conversion relationship between each of the lidars and the integrated navigation data are calculated. In Step S110, each of a plurality of lidars installed on an autonomous driving vehicle collects a set of dynamic raw point cloud data within a respective visual space in real time. Meanwhile, the autonomous driving vehicle is also equipped with an integrated navigation apparatus, which acquires a set of integrated navigation data in real time.

Therefore, in Step S110 multiple sets of dynamic raw point cloud data from the plurality of lidars and a set of integrated navigation data from the integrated navigation apparatus are first obtained. Based on the obtained data, the extrinsic parameters of the lidars and the integrated navigation apparatus are initialized to obtain an initial extrinsic parameter characterizing the conversion relationship between each of the lidars and the integrated navigation data. In one embodiment, the initial extrinsic parameter refers to a rotating extrinsic-parameter matrix characterizing a conversion relationship between one lidar and the integrated navigation data.

In Step S120, with a point model on a scanned surface of real space which obeys a normal distribution, differences between lidar clock sources, and vehicle vibration taken into account, the initial extrinsic parameter (of each lidar) and the integrated navigation data determined in Step S110 are adjusted, so as to obtain the extrinsic parameter between each lidar and the integrated navigation apparatus, denoted as a first-type extrinsic parameter, and optimized integrated navigation data. Hence, the first-type extrinsic parameter that is more accurate and the optimized integrated navigation pose are obtained in the present application, while the influence of vehicle vibration and time synchronization on the positioning data from the integrated navigation apparatus is taken into consideration. In particular, the first-type extrinsic parameter as calibrated is not restricted by factors such as environment and sensor types, and the calibration can be performed in an unstructured environment.

Then in Step S130, according to the first-type extrinsic parameter of each lidar determined in Step S120, a compensation matrix for compensating a vertical component of the extrinsic parameter corresponding to each lidar and the integrated navigation apparatus is obtained.

Finally, second-type extrinsic parameters between lidars are obtained in Step S140 according to the compensation matrix of each lidar, the first-type extrinsic parameter thereof, and the optimized integrated navigation data.

In this manner, a more accurate estimation of the second-type extrinsic parameter can be obtained in the present invention by optimizing the poses of lidars and thus indirectly optimizing the extrinsic parameters of lidars, while the influence of uneven ground on the integrated navigation apparatus and that of time synchronization on the calibration of multiple lidars are taken into consideration.

Prior to a detailed description of steps in the integrated calibration method according to the present invention, definitions of symbols and probabilistic modeling of point in the embodiments of the present invention are illustrated as follows.

### Definitions of Symbols

A world coordinate system is denoted as {W}, and a positioning center of the integrated navigation apparatus is denoted as {G}. _{A}^{B}T∈SE(3) refers to the coordinate transformation from coordinate system A to coordinate system B. [symbol] ={L₀, L₁, . . . , Lₘ₋₁} refers to a collection of m lidars, wherein L₀ denotes a main lidar. [symbol] _{L}={_{L}_{₁}^{L}^{₀}T, _{L}_{₂}^{L}^{₀}T, . . . , _{L}_{ₘ₋₁}^{L}^{₀}T} denotes extrinsic parameters between lidars, and [symbol] _{G}={_{L}_{₀}^{G}T, _{L}_{₁}^{G}T, . . . , _{L}_{ₘ₋₁}^{G}T} denotes extrinsic parameters between lidars and the integrated navigation apparatus.

[symbol] _{L}_{ᵢ}={_{L}_{ᵢ}^{W}Tₜ_{₀}, _{L}_{ᵢ}^{W}Tₜ_{₁}, . . . , _{L}_{ᵢ}^{W}Tₜ_{ⱼ}} refers to a pose of Lᵢ at the time tⱼ∈ [symbol] ={t₀, t₁, . . . , tⱼ₋₁}, and [symbol] _{G}={_{G}^{W}Tₜ_{₀}, _{G}^{W}Tₜ_{₁},·, _{G}^{W}Tₜ_{ⱼ}} refers to a pose of G at the time tⱼ∈ [symbol] ={t₀, t₁, . . . , tⱼ₋₁}. The point cloud scanned by the lidar Lᵢ∈ [symbol] at the time tⱼ∈ [symbol] is denoted as ^{L}^{ᵢ} [symbol] ₜ_{ⱼ}, which is located in the local coordinate system of Lᵢ. Finally, [symbol] _{L}=∪_{L}_{ᵢ} [symbol] _{L}_{ᵢ} refers to poses of all lidars.

### Probabilistic Modeling of Point

It is assumed that a spatial point is observed by multiple lidars, and has different coordinates in the local coordinate systems of different lidars. However, points sampled by multiple lidars are not identical due to different distribution and scanning patterns of point cloud sampling. Specifically, due to the segmented and differentiable real-world surface scanned by the lidar, a plurality of measurement points scanned by the lidar will be located on a corresponding local surface. Therefore, each scanned measurement point can be modeled, and the model obtained obeys a normal distribution, which is expressed as follows:

$$P ∼ N ( \hat{p} , \sum ) = N ( \hat{p} , R ( \begin{matrix}1 & 0 & 0 \\ 0 & 1 & 0 \\ 0 & 0 & ϵ\end{matrix} ) {R}^{T} ) \qquad ( 1 )$$

wherein p denotes a scanning point, N( ) denotes normal distribution, \hat{p} denotes the mean of the distribution, Σ denotes the covariance of the distribution, R denotes a rotation matrix that rotates the base vector, R^{T} denotes the transposition of the matrix, and ϵ denotes the uncertainty along the surface normal. It can be assumed that all measurement points on the same segmented surface are distributed on a local plane. Therefore, the local planes corresponding to each point are aligned as much as possible in the embodiments of the present invention. In actual practice, a number of point pairs are constructed through associating measurement points on the same local plane by, for example, KD-tree search.

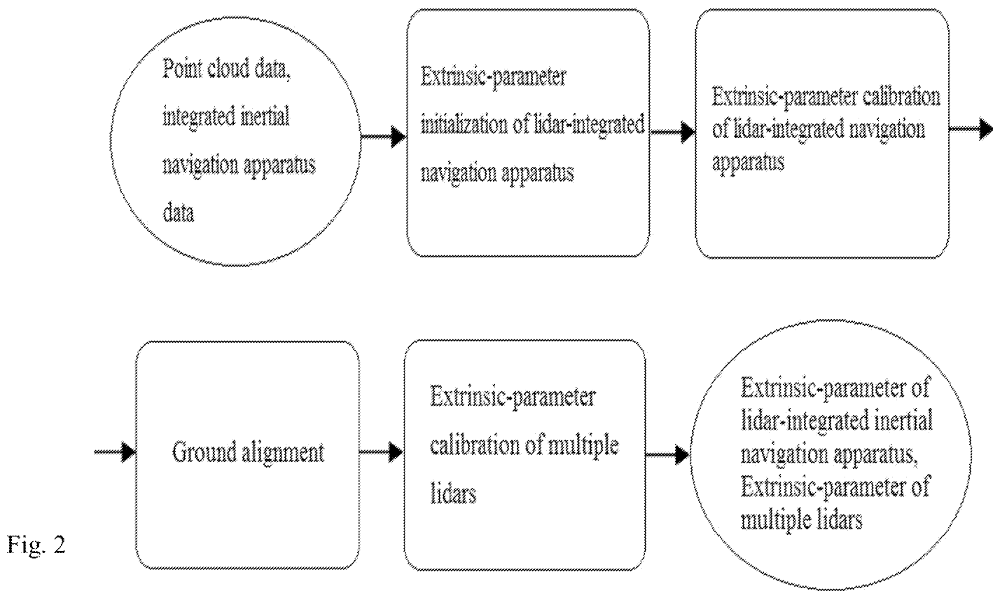

FIG. 2 is a flow diagram showing the method of calibration for multi-lidar and integrated navigation according to embodiments of the present application. The specific steps of the integrated calibration method according to embodiments of the present application are described as follows in detail with reference to FIG. 2.

As shown in FIG. 2, the extrinsic parameter [symbol] _{G} between the lidar and the integrated navigation apparatus, and the extrinsic parameter [symbol] _{L} between multiple lidars are calibrated sequentially, wherein input of additional initial values is not required in the present invention. First, data from the lidar and the integrated navigation apparatus are input into an extrinsic-parameter initialization module of a lidar-integrated navigation apparatus (also referred to as “integrated inertial navigation apparatus”) for initialization. In the initialization process, a global optimization solver is adopted to solve a constructed optimization problem, thus estimating initial extrinsic parameters between lidars and the integrated navigation apparatus. Subsequently, a two-stage approach is adopted to estimate the extrinsic parameters of the lidar-integrated navigation apparatus. The first stage is a rough calibration stage, in which a model is constructed and optimized without considering errors in the positioning data, and the results of rough calibration are obtained. The second stage is a precise calibration stage, in which the influence of vehicle vibration and time asynchrony on the positioning precision is taken into account, and a more comprehensive model is constructed and optimized, in order to obtain the results of precise calibration. The ground alignment aims to compensate for the extrinsic parameters of the lidar-integrated navigation apparatus (since the vehicle is in planar motion, which not observable along the direction perpendicular to the ground, i.e., the component of this direction in the extrinsic parameters is inaccurate), and to calculate the initial poses of the lidars based on the extrinsic parameters after compensation. Finally, the poses of all lidars are optimized according to the constructed model, based on which the extrinsic parameters between multiple lidars are indirectly calculated.

In Step S110, the embodiments of the present invention, based on the obtained multiple sets of raw point cloud data and the raw integrated navigation data, calculate the initial extrinsic parameter characterizing the conversion relationship between each of the lidars and the raw integrated navigation data.

Specifically, in Step S1101 (not shown), the raw point cloud data of all lidars are transformed from the lidar coordinate system to the world coordinate system, and then registration of point clouds is performed to obtain a local point cloud map model of each lidar, which contains the first-type extrinsic parameters between respective lidars and the integrated navigation apparatus. Then, in Step S1102 (not shown), a rotation matrix between each lidar and the integrated navigation apparatus is constructed, taking a sum of distances between point pairs as the error, wherein each point pair contains a point and the nearest point thereof in the local point cloud map model generated in Step S1101, and the rotation matrix is formed with error minimization solving. Finally, in Step S1103 (not shown), the value of the translation matrix is assigned to zero, and the rotation matrix between each lidar and the integrated navigation apparatus is solved, in order to obtain an initial rotation matrix for each lidar characterizing the initial extrinsic parameter.

Typically, the initial extrinsic parameter of each lidar and the integrated navigation apparatus in the corresponding vehicle can be obtained through a computer-aided design (CAD) model of the vehicle or the hand-eye calibration method. However, in some cases, the initial extrinsic parameter cannot be obtained because the CAD model is unavailable or the lidar odometer cannot be accurately estimated. Therefore, a global optimization solver is employed in the embodiments of the present invention to solve the optimization problem below and obtain the extrinsic parameters between the lidars and the integrated navigation apparatus.

Firstly, the raw point cloud data collected by all the lidars in the autonomous driving vehicle in real time are transformed from the lidar coordinate system to the world coordinate system, and registration of all point cloud data is performed to obtain a local point cloud map of each lidar in the world coordinate system, wherein multiple segmented surfaces are formed in each local point cloud map, and each segmented surface comprises a plurality of measurement points. The local point cloud map model is expressed as follows:

$${𝕄}_{{L}_{i}} = \{ {}^{W} {p}_{{t}_{j}}^{k} = {}_{G}^{W} {T}_{{t}_{j}} {}_{{L}_{i}}^{G} {T}^{{L}_{i}} {p}_{{t}_{j}}^{k} \vert {}^{{L}_{i}} {p}_{{t}_{j}}^{k} ∈ {}^{{L}_{i}} {ℙ}_{{t}_{j}} , {t}_{j} ∈ {𝒯}_{{L}_{i}} \} \qquad ( 2 )$$

wherein [symbol] _{L}_{ᵢ} denotes the local point cloud map model, ^{L}^{ᵢ} [symbol] ₜ_{ⱼ} denotes the raw point cloud data scanned by the lidar Lᵢ, [symbol] denotes a collection of time corresponding to all points, ^{L}^{ᵢ}pₜ_{ⱼ}^{k} denotes a model of the k^{th} point in ^{L}^{ᵢ} [symbol] ₜ_{ⱼ}, ^{W}pₜ_{ⱼ}^{k} denotes ^{L}^{ᵢ}pₜ_{ⱼ}^{k} represented in world coordinate system, _{G}^{W}Tₜ_{ⱼ} denotes a pose of a positioning center of the integrated navigation apparatus of a vehicle at a sampling moment tᵢ, and _{L}_{ᵢ}^{G}T denotes the extrinsic parameter (to be estimated) between the lidar Lᵢ and the integrated navigation apparatus.

Then, a nearest point is scanned for each point in the local point cloud map model, and the distances between all point pairs are summed as the error, which is minimized to solve the rotation matrix between the lidar and the integrated navigation apparatus, wherein the translation matrix is set to 0. The rotation matrix is expressed as follows:

$${}_{{L}_{i}}^{G} {R}_{init} = arg {min}_{{}_{{L}_{i}}^{G} R} ( kNNError ( {𝕄}_{{L}_{i}} ) ) \qquad ( 3 )$$

wherein Lᵢ^{G}Rᵢₙᵢₜ denotes the rotation matrix between the lidar Lᵢ and the integrated navigation apparatus, and kNNError( ) denotes the error in map calculation.

Finally, the right side of the expression (3) above is solved through the Constrained Optimization by Linear Approximations (COBYLA) method provided in the NLopt library, thus obtaining the rotation matrix of initial extrinsic parameter of each lidar _{L}_{ᵢ}^{G}Rᵢₙᵢₜ, and forming the set _{L}^{G}Rᵢₙᵢₜ composed of all _{L}_{ᵢ}^{G}Rᵢₙᵢₜ.

Then in Step S120, after the rotation matrix of initial extrinsic parameter between each lidar and the integrated navigation apparatus is obtained, calibration between the lidars and the integrated navigation apparatus is performed.

Specifically, in Step S1201 (not shown), a first surface-to-surface distance between local surfaces in the real space where any two points sampled by the same lidar are located is calculated first. Then, based on the first surface-to-surface distance obtained in Step S1201, the rotation matrix of initial extrinsic parameter of each lidar, and the raw integrated navigation data of the vehicle, an extrinsic-parameter rough adjustment model for roughly adjusting the extrinsic parameters between the lidars and the integrated navigation apparatus is constructed in Step S1202 (not shown), while taking into consideration the point model on the scanned surface of real space which obeys a normal distribution. Then, in Step S1203 (not shown), the extrinsic-parameter rough adjustment model is solved through minimized estimation, in order to obtain an estimated rotation matrix of extrinsic parameter of each lidar. Next, based on the first surface-to-surface distance obtained in Step S1201, the estimated rotation matrix of extrinsic parameter of each lidar, and the raw integrated navigation data of the vehicle, the extrinsic-parameter adjustment model for precisely adjusting the extrinsic parameter between each lidar and the integrated navigation apparatus is constructed, while taking into consideration the differences between the lidar clock sources and the vehicle vibration. Finally, in Step S1204 (not shown), the extrinsic-parameter adjustment model is solved through minimum estimation, in order to obtain the first-type extrinsic parameter for each lidar and the optimized integrated navigation pose.

First, the distance between the local planes (local surfaces) where any two measurement points in the same lidar are located is denoted as the first surface-to-surface distance and obeys a normal distribution, which is calculated with the following expression:

$$\begin{matrix}{}^{{L}_{i}} {d}_{{t}_{i} {t}_{j}}^{kl} = {}_{G}^{W} {T}_{{t}_{i}} {}_{{L}_{i}}^{G} {T}^{{L}_{i}} {p}_{{t}_{i}}^{k} - {}_{G}^{W} {T}_{{t}_{j}} {}_{{L}_{i}}^{G} {T}^{{L}_{i}} {p}_{{t}_{j}}^{l} \\ = {}_{{L}_{i}}^{W} {T}_{{t}_{i}} {}^{{L}_{i}} {p}_{{t}_{i}}^{k} - {}_{{L}_{i}}^{W} {T}_{{t}_{j}} {}^{{L}_{i}} {p}_{{t}_{j}}^{l}\end{matrix} \qquad ( 4 )$$

wherein _{L}_{ᵢ}dₜ_{ᵢ}ₜ_{ⱼ}^{kl} denotes the first surface-to-surface distance between a local plane (surface) where the k^{th} point sampled by lidar Lᵢ at a moment tᵢ is located and a local plane (surface) where the l^{th} point sampled thereby at a moment tⱼ is located, _{L}_{ᵢ}^{G}T denotes the extrinsic parameter (to be estimated) between the lidar Lᵢ and the integrated navigation apparatus, _{G}^{W}Tₜ_{ᵢ} and _{G}^{W}Tₜ_{ⱼ} denote poses of a positioning center of the integrated navigation apparatus of a vehicle at moments tᵢ and tⱼ, respectively, ^{L}^{ᵢ}pₜ_{ᵢ}^{k} and ^{L}^{ᵢ}pₜ_{ⱼ}^{l} denote a model of the k^{th} point sampled by the lidar Lᵢ and a model of the l^{th} point sampled thereby at the moment tⱼ, respectively, and _{L}_{ᵢ}^{W}Tₜ_{ᵢ} and _{L}_{ᵢ}^{W}Tₜ_{ⱼ} denote poses of the lidar Lᵢ at the moments tᵢ and tⱼ, respectively.

The following expression (5) is an expression of the extrinsic-parameter rough adjustment model, which is constructed based on the surface-to-surface distances between different point pairs as well as the rotation matrix of initial extrinsic parameter obtained in Step S110. By solving the right part of the following expression (5), the estimated rotation matrix of extrinsic parameter of each lidar is obtained, i.e., the rough-estimated extrinsic parameters between each of the lidars and the integrated navigation apparatus.

The extrinsic-parameter rough adjustment model is expressed as follows:

$${}_{{L}_{i}}^{G} T = arg {min}_{{}_{{L}_{i}}^{G} T} ( {\sum }_{{t}_{i} , {t}_{j}} {\sum }_{k , l} ρ ( {‖ {}^{{L}_{i}} {d}_{{t}_{i} {t}_{j}}^{kl} ‖}_{{\sum }_{{t}_{i} {t}_{j}}^{kl}}^{2} ) + {‖ Log ( {}_{{L}_{i}}^{G} {R}^{- 1} {( {}_{{L}_{i}}^{G} R )}_{prior} ) ‖}_{{\sum }_{R}}^{2} ) \qquad ( 5 )$$

wherein _{L}_{ᵢ}^{G}T denotes the extrinsic-parameter rough adjustment model of the lidar Lᵢ, ρ( ) denotes a robust kernel function, Σₜ_{ᵢ}ₜ_{ⱼ}^{kl} denotes a covariance matrix of a first residual block (for the calculation of the mahalanobis distance), (_{L}_{ᵢ}^{G}R)ₚᵣᵢₒᵣ denotes the initial rotation matrix of extrinsic parameter between the lidar Lᵢ and the integrated navigation apparatus, _{L}_{ᵢ}^{G}R⁻¹ denotes the estimated rotation matrix of extrinsic parameter between the lidar Lᵢ to be estimated and the integrated navigation apparatus, Log( ) denotes a symbol that directly maps SO(3) space to [symbol] ³ vector space, and Σ_{R} denotes a covariance matrix of a second residual block (for the calculation of the mahalanobis distance).

In the real world, there are two factors that may affect the accuracy of the above rough estimation results of extrinsic parameters. First, uneven ground conditions may lead to vibrations of vehicle body. Second, minor misalignment of timestamps may occur due to different clock sources. Overall, these two factors may lead to deviation in the pose output by the integrated navigation apparatus corresponding to each frame of point cloud data, which may in turn lead to deviation in the estimation of extrinsic parameters.

Therefore, in order to improve the results in rough calibration, precise calibration is performed by jointly optimizing the pose of the integrated navigation apparatus and the extrinsic parameters between the lidars and the integrated navigation apparatus. In the embodiments of the present invention, on the basis of the surface-to-surface distances between different point pairs, the extrinsic-parameter matrix (the estimated rotation matrix of extrinsic parameters) obtained in rough calibration, and the positioning data of the integrated navigation apparatus, the right part in the following expression (6) is solved, thus obtaining the first-type extrinsic parameter of each lidar, i.e., the precise extrinsic parameter between each lidar and the integrated navigation apparatus. At the same time, the optimized integrated navigation pose is obtained.

The extrinsic-parameter adjustment model is expressed as follows:

$${}_{{L}_{i}}^{G} T = arg {min}_{{𝕋}_{G} , {}_{{L}_{i}}^{G} T} ( {\sum }_{{t}_{i} , {t}_{j}} {\sum }_{k , l} ρ ( {‖ {}^{{L}_{i}} {d}_{{t}_{i} {t}_{j}}^{kl} ‖}_{{\sum }_{{t}_{i} {t}_{j}}^{kl}}^{2} ) + {\sum }_{{t}_{i}} {‖ Log ( {}_{G}^{W} {T}_{{t}_{i}}^{- 1} {( {}_{G}^{W} {T}_{{t}_{i}} )}_{prior} ) ‖}_{{\sum }_{T}}^{2} + {‖ {Log}^{′} ( {}_{{L}_{i}}^{G} {T}^{- 1} {( {}_{{L}_{i}}^{G} T )}_{prior} ) ‖}_{{\sum }_{T}}^{2} ) \qquad ( 6 )$$

wherein _{L}_{ᵢ}^{G}T denotes the extrinsic-parameter adjustment model of the lidar Lᵢ, Σₜ_{ᵢ}ₜ_{ⱼ}^{kl} denotes the covariance matrix of the first residual block (for the calculation of the mahalanobis distance), (_{G}^{W}Tₜ_{ᵢ})ₚᵣᵢₒᵣ denotes the integrated navigation data measured in real time by the integrated navigation apparatus, _{G}^{W}Tₜ_{ᵢ}⁻¹ denotes the optimized integrated navigation pose to be estimated, Σ_{T} denotes the covariance matrix of the second and third residual blocks (for the calculation of the mahalanobis distance), (_{L}_{ᵢ}^{G}T)ₚᵣᵢₒᵣ denotes the estimated rotation matrix of extrinsic parameter of the lidar Lᵢ after rough adjustment, _{L}_{ᵢ}^{G}T⁻¹ denotes the first-type extrinsic parameter of the lidar Lᵢ to be estimated, and Log′ ( ) denotes the symbol that directly maps the SE(3) space to the [symbol] ⁶ vector space.

After obtaining the precise extrinsic parameter between each of the lidars and the integrated inertial navigation apparatus, Step S130 is proceeded to construct a matrix for compensating the extrinsic parameter between each lidar and the integrated navigation apparatus.

In Step S130, a compensation matrix for aligning ground planes in the point cloud data of any two lidars is constructed and solved according to denotations of a specified point on the surface of the real space in different lidar coordinate systems, wherein the preset target positioning center is taken as a reference, and the first-type extrinsic parameters of different lidars are taken as corresponding degeneration parameters.

In the embodiments of the present invention, the purpose of ground alignment is to compensate for the extrinsic parameters between the lidars and the integrated navigation apparatus. Because the trajectory of vehicle is typically on an approximate plane without significant motion perpendicular to the ground, unobservable components of the extrinsic parameters between the lidars and the integrated navigation apparatus are introduced.

Hence, in the embodiments of the present invention, the following expression is constructed with the compensation matrix:

$${}_{{L}_{i}}^{{G}_{i}} {T}^{{L}_{i}} p = {}_{{G}_{j}}^{{G}_{i}} {T}_{{L}_{j}}^{{G}_{j}} {T}^{{L}_{j}} p \qquad ( 7 )$$

wherein _{L}_{ᵢ}^{G}^{ᵢ}T and _{L}_{ⱼ}^{G}^{ⱼ}T denote the first-type extrinsic parameters, as degeneration extrinsic-parameters, of lidars Lᵢ and Lⱼ, respectively, _{G}_{ⱼ}^{G}^{ᵢ}T denotes the compensation matrix, and ^{L}^{ᵢ}p and ^{L}^{ⱼ}p denote a same specified point on the surface of the real space represented in coordinate systems {Lᵢ} and {Lⱼ}, respectively.

When solving the above compensation matrix, the expression (7) is first transformed as a point-cloud registration expression, and then the parameter in the compensation matrix is decomposed into a coordinate rotation matrix parameter and a coordinate translation matrix parameter, in order to calculate a corresponding coordinate rotation matrix and a corresponding coordinate translation matrix by extracting the ground planes in the point cloud data of the two lidars. Finally, the solved results of the compensation matrix are obtained.

The expression (7) is simplified to obtain the point-cloud registration expression, which is expressed as follows:

$${}^{{G}_{i}} p = {}_{{G}_{j}}^{{G}_{i}} {R}^{{G}_{j}} p + {}_{{G}_{j}}^{{G}_{i}} t \qquad ( 8 )$$

wherein ^{G}^{ᵢ}p denotes a specified point on the surface of the real space in lidar coordinate system {Gᵢ}, _{G}_{ⱼ}^{G}^{ᵢ}R denotes the coordinate rotation matrix of the specified point on the surface of the real space from lidar coordinate systems {Gⱼ} to {Gᵢ}, ^{G}^{ⱼ}p denotes the specified point on the surface of the real space in the lidar coordinate system {Gⱼ}, and _{G}_{ⱼ}^{G}^{ᵢ}t denotes the coordinate translation matrix of the specified point on the surface of the real space from the lidar coordinate systems {Gⱼ} to {Gᵢ}.

The form of expression (8) above is equivalent to the registration of point cloud. In case of inaccurate initial values or low overlap between lidars, the registration result of point cloud may diverge. Since the characteristics of the unobservable direction (i.e., vertical direction) are known, the above expression (8) can be further simplified to align the ground of two lidar point clouds, thus obtaining approximation of the coordinate rotation matrix _{G}_{ⱼ}^{G}^{ᵢ}R and the coordinate translation matrix _{G}_{ⱼ}^{G}^{ᵢ}t.

The coordinate rotation matrix and the coordinate translation matrix are expressed as follows:

$$\{ \begin{matrix}u = \frac{{n}_{1} \times {n}_{2}}{‖ {n}_{1} \times {n}_{2} ‖} \\ θ = arc cos ( {n}_{1} \cdot {n}_{2} ) \\ R = I + {[ u ]}_{\times } sin θ + {[ u ]}_{\times }^{2} ( 1 - cos θ ) \\ t = {[ 0 , 0 , {d}_{1} - {d}_{2} ]}^{T}\end{matrix} \qquad ( 9 )$$

wherein [n₁^{T}, d₁] and [n₂^{T}, d₂] denote parameters of the ground planes where the specified point on the surface of the real space is located represented in the lidar coordinate systems {Gᵢ} and {Gⱼ}, respectively, n₁ and n₂ denote normal vectors of two ground planes respectively, d₁ and d₁ denote intercepts of the two ground planes respectively, u denotes a unit vector orthogonal to both n₁ and n₂, θ denotes an angle between n₁ and n₂, R denotes the coordinate rotation matrix, t denotes the coordinate translation matrix, I denotes identity matrix, and T denotes transposition symbol.

After the compensation matrix for each lidar is obtained, Step S140 is proceeded to calibrate the extrinsic parameters between the multiple lidars.

First, the initial poses of each lidar at all moments are calculated in Step S1401 (not shown), based on the optimized integrated navigation pose in Step S120, the compensation matrix of each lidar in Step S130, and the first-type extrinsic parameter of each lidar in Step S130. Then in Step S1402 (not shown), based on the initial poses of each lidar at all moments, a second surface-to-surface distance between local surfaces of the real space where two sampling points in different sampling spaces for any two lidars at any sampling moments are located, or between sampling points of the same lidar at any two sampling moments, is calculated. In Step S1403 (not shown), a pose optimization model for calculating the poses of each lidar at all sampling moments is constructed based on the second surface-to-surface distance in Step S1402 and the initial pose of each lidar in Step S1401. Next, in Step S1404 (not shown), the pose optimization model constructed in Step S1403 is solved through iterative computations to obtain the poses of different lidars at all moments. Finally, in Step S1405 (not shown), the extrinsic parameter of each lidar with respect to a main lidar is calculated based on the poses of different lidars at all moments in Step S1404, thereby obtaining the second-type extrinsic parameters between individual lidars.

In the embodiments of the present invention, the extrinsic parameters between multiple lidars are not estimated directly, because this may be affected by inconsistent time synchronization between lidars. Instead, the extrinsic parameters between the lidars are obtained indirectly by optimizing the poses of the lidars.

First, the initial poses of all lidars are calculated based on the compensation matrix in combination with the optimized positioning data of the integrated navigation apparatus, wherein the initial pose of each lidar is calculated with the following expression:

$${( {𝕋}_{L} )}_{init} = \{ {}_{{L}_{m}}^{W} {T}_{{t}_{i}} = {}_{{G}_{0}}^{W} {T}_{{t}_{i}} {}_{{G}_{m}}^{{G}_{0}} {T}_{{L}_{m}}^{{G}_{m}} T \vert {}_{{G}_{0}}^{W} T ∈ {𝕋}_{G} , {}_{{L}_{m}}^{{G}_{m}} T ∈ {𝕋}_{c} , {}_{{L}_{m}}^{{G}_{m}} T ∈ {𝔼}_{G} , {L}_{m} ∈ 𝕃 , {t}_{i} ∈ {𝒯}_{{L}_{m}} \} \qquad ( 10 )$$

wherein ( [symbol] _{L})ᵢₙᵢₜ denotes initial poses of all lidars, _{L}_{ₘ}^{W}Tₜ_{ᵢ} denotes the initial pose of lidar Lₘ at moment tᵢ, G₀ denotes the target positioning center, _{G}_{₀}^{W}T denotes the optimized integrated navigation pose at the moment tᵢ, _{G}_{ₘ}^{G}^{₀}T denotes the compensation matrix of the lidar Lₘ, _{L}_{ₘ}^{G}^{ₘ}T denotes a matrix of the first-type extrinsic parameter of the lidar Lₘ, [symbol] _{G} denotes a set of poses of the optimized integrated navigation apparatus, [symbol] _{c} denotes a set of the compensation matrix, [symbol] _{G} denotes a set of the first-type extrinsic parameters between the lidars and the integrated navigation apparatus, [symbol] denotes a set of the lidars, and [symbol] denotes a set of time.

Next, the second surface-to-surface distance is calculated with the following expression:

$${( {d}_{{t}_{i} {t}_{j}}^{kl} )}_{m n} = {}_{{L}_{m}}^{W} {T}_{{t}_{i}} {}^{{L}_{m}} {P}_{{t}_{i}}^{k} - {}_{{L}_{n}}^{W} {T}_{{t}_{j}} {}^{{L}_{m}} {P}_{{t}_{j}}^{l} \qquad ( 11 )$$

wherein (dₜ_{ᵢ}ₜ_{ⱼ}^{kl})ₘₙ denotes the second surface-to-surface distance between the local plane (surface) where the k^{th} point sampled by the lidar Lₘ at the moment tᵢ is located and the local plane (surface) where the l^{th} point sampled by the lidar Lₙ at the moment tⱼ is located, _{L}_{ₘ}^{W}Tₜ_{ᵢ} denotes the initial poses of the lidar Lₘ at the moment tᵢ, _{L}_{ₙ}^{W}Tₜ_{ⱼ} denotes the initial poses of the lidar Lₙ at the moment tⱼ, and ^{L}^{ₘ}pₜ_{ᵢ}^{k} and ^{L}^{ₙ}pₜ_{ⱼ}^{l} denote the k^{th} point sampled by the lidar Lₘ at the moment tᵢ and the l^{th} point sampled by the lidar Lₙ at the moment of tⱼ, respectively.

In the embodiments of the present invention, the pose optimization model is constructed based on the surface-to-surface distances between different point pairs and the initial pose of the main lidar at the moment t0. The right side of the expression (12) is solved through iterative computations, thus obtaining the poses of all lidars at all moments. The pose optimization model is expressed as follows:

$${𝕋}_{L} = arg {min}_{{𝕋}_{L}} ( {\sum }_{m , n} {\sum }_{{t}_{i} , {t}_{j}} {\sum }_{k , l} ρ ( {‖ {( {d}_{{t}_{i} {t}_{j}}^{kl} )}_{mn} ‖}_{{( {\sum }_{{t}_{i} {t}_{j}}^{kl} )}_{mn}}^{2} ) + {‖ {Log}^{′} ( {}_{{L}_{0}}^{W} {T}_{{t}_{0}}^{- 1} {( T )}_{identity} ) ‖}_{{\sum }_{T}}^{2} ) \qquad ( 12 )$$

wherein (Σₜ_{ᵢ}ₜ_{ⱼ}^{kl})ₘₙ denotes a covariance matrix of a first residual block (for calculation of the mahalanobis distance), _{L}_{₀}^{W}Tₜ_{₀} denotes the pose of lidar L₀ to be estimated at a moment t₀, (T)_{identity} denotes an identity matrix formed by the initial poses of the main lidar L₀, Σ_{T} denotes a covariance matrix of a second residual block (for calculation of the mahalanobis distance), and Log′ ( ) denotes a symbol that directly maps SE(3) space to [symbol] ⁶ vector space.

The expression (12) is solved through iterative computations, i.e., based on the results of a previous estimation, until a specific condition is met. Since the optimization is performed through iterative computations, the more accurate the initial value is, the better the speed and precision of the optimization will be. The result in the expression (10) is the initial value in the expression (12). Specifically, when the expression (11) is calculated for the first time, _{L}_{ₘ}^{W}Tₜ_{ᵢ} and _{L}_{ₙ}^{W}Tₜ_{ⱼ} are the initial poses calculated in the expression (10).

After the poses of the lidars are optimized, the extrinsic parameter between individual lidars, i.e., the second-type extrinsic parameter between individual lidars is calculated with the following expression:

$${}_{{L}_{m}}^{{L}_{0}} T = Exp ( \frac{1}{\vert {𝒯}_{sync} \vert} {\sum }_{{t}_{i}} {{Log}^{′} ( {(}_{{L}_{0}}^{W} {T}_{{t}_{i}} )}^{- 1} {}_{{L}_{m}}^{W} {T}_{{t}_{i}} ) ) \qquad ( 13 )$$

wherein _{L}_{ₘ}^{L}^{₀}T∈ [symbol] _{G} denotes the second-type extrinsic parameter between lidars L₀ and Lₘ, _{L}_{₀}^{W}Tₜ_{ᵢ} denotes an estimated pose of the lidar L₀ at the moment tᵢ, Lₘ denotes a pose of the lidar Lₘ to be estimated at the moment tᵢ, Exp( ) denotes a symbol that directly maps the [symbol] ⁶ vector space to the SE(3) space, Log′ ( ) denotes the symbol that directly maps the SE(3) space to the [symbol] ⁶ vector space, and [symbol] denotes a set of timestamps that have been synchronized.

Furthermore, prior to the calculation of the second-type extrinsic parameters between individual lidars with the above expression (12), anomalous poses are removed from the poses of different lidars at all moments based on 3σ principle, so as to obtain more precise second-type extrinsic parameters in the embodiments of the present invention.

### Example 2

Based on the above integrated calibration method, the embodiments of the present invention further provide a computer-readable storage medium with a computer program stored thereon. The computer program is executed to perform a method of calibration for multi-lidar and integrated navigation. The computer program is capable of executing computer instructions which comprise computer program codes that may be in forms of source code, object code, executable file, or in intermediate forms, etc.

The computer-readable storage medium may include any entity or device that contains computer program codes, such as recording medium, USB flash disk, removable hard disk, diskette, optical disc, computer memory, ROM (Read-Only Memory), RAM (Random Access Memory), power line carrier signal, telecommunication signal, software distribution medium, etc.

It should be noted that the content in computer-readable storage media may be modified as appropriate in accordance with the requirements of legislation and patent practice in different jurisdictions. For example, the computer-readable storage medium may include no power line carrier signal or telecommunication signal, according to the patent practice in some jurisdictions.

### Example 3

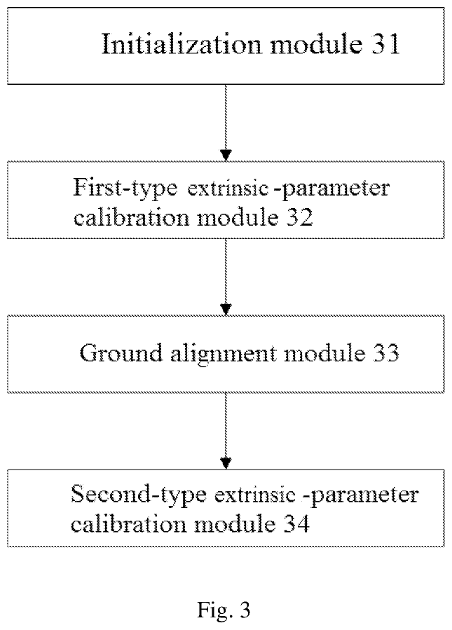

Based on the above method of integrated calibration, the embodiments of the present invention further propose a system for achieving calibration for multi-lidar and integrated navigation (also referred to as “an integrated calibration system”). FIG. 3 shows modules of a system of calibration for multi-lidar and integrated navigation according to embodiments of the present application. As shown in FIG. 3, the integrated calibration system according to the embodiments of the present invention comprises an initialization module 31, a first-type extrinsic-parameter calibration module 32, a ground alignment module 33 and a second-type extrinsic-parameter calibration module 34.

Specifically, the initialization module 31 is configured to, according to the method described in Step S110 above, obtain raw point cloud data from multiple lidars and integrated navigation data from an integrated navigation apparatus, and calculate an initial extrinsic parameter characterizing a conversion relationship between each lidar and the integrated navigation data. The first-type extrinsic-parameter calibration module 32 is configured to, according to the method described in Step S120 above, adjust the initial extrinsic parameter and the integrated navigation data, taking into account factors including a point model on a scanned surface of real space which obeys a normal distribution, differences between lidar clock sources and vehicle vibration, thus obtaining a first-type extrinsic parameter between each lidar and the integrated navigation apparatus, as well as optimized integrated navigation data. The ground alignment module 33 is configured to, according to the method described in Step S130 above, obtain, based on the first-type extrinsic parameters, a compensation matrix for compensating a vertical component of an extrinsic parameter between each lidar and the integrated navigation apparatus. The second-type extrinsic-parameter calibration module 34 is configured to, according to the method described in Step S140 described above, obtain a second-type extrinsic parameters between individual lidars based on the compensation matrix and the first-type extrinsic parameter of each lidar as well as the optimized integrated navigation data.

The present invention discloses a method and system of calibration for multi-lidar and integrated navigation. The method and system dispense with the need for any additional inputs such as, for example, acquisition of initialization data and preparation of calibration objects, as well as pre-calibration preparations, and provides a complete and automated calibration algorithm for multi-lidar and integrated navigation that can ultimately yield extrinsic parameters between each lidar and the integrated navigation apparatus as well as between multiple lidars. Moreover, the present invention depends less on the environment and is not limited to specific types of sensor (e.g., lidar). In the present invention, the model is constructed directly based on points to optimize solution, so the specific artificial feature of the environment is not required. In the meantime, the present invention is applicable to calibration in both structured artificial environment and unstructured natural environment, and the point-based model is applicable to all types of lidars. In addition, the present invention takes into consideration the influence of uneven ground and time synchronization on the positioning precision of the integrated navigation apparatus, thereby improving the precision and accuracy of the extrinsic-parameter calibration between the lidar and the integrated navigation apparatus, with an increase of approximately 20%. Furthermore, the present invention takes into consideration the influence of time synchronization on the calibration of multiple lidars, and estimates the extrinsic parameters of lidar indirectly by estimating the poses of lidar, thus yielding more accurate estimation results without precise time synchronization between multiple lidars.

The foregoing is merely illustrative of preferred embodiments of the present invention, but the scope of protection of the present invention is not limited thereto. Any modifications or substitutions that can be readily conceived by one skilled in the art within the technical scope disclosed herein shall fall within the scope of protection of the present invention. Therefore, the scope of protection of the present invention should be determined according to the scope of protection of the claims.

1. A method of calibration for multi-lidar and integrated-navigation, comprising steps of:
obtaining raw point cloud data from multiple lidars and integrated navigation data from an integrated navigation apparatus, and calculating an initial extrinsic parameter characterizing a conversion relationship between each lidar and said integrated navigation data;
adjusting the initial extrinsic parameter and the integrated navigation data to obtain a first-type extrinsic parameter between each lidar and the integrated navigation apparatus, as well as optimized integrated navigation data, while taking into consideration a point model on a scanned surface of real space which obeys a normal distribution, differences between lidar clock sources, and vehicle vibration;
obtaining, according to the first-type extrinsic parameter, a compensation matrix for compensating a vertical component of an extrinsic parameter between each lidar and the integrated navigation apparatus; and
obtaining a second-type extrinsic parameter between individual lidars according to the compensation matrix and the first-type extrinsic parameter of each lidar as well as the optimized integrated navigation data.

2. The method according to claim 1, wherein each initial extrinsic parameter is calculated through steps of:
transforming the raw point cloud data of all lidars from a lidar coordinate system to a world coordinate system for point cloud registration, thus obtaining a local point cloud map model of each lidar, which contains the extrinsic parameter to be estimated between a respective lidar and the integrated navigation apparatus;
searching a nearest point of each point in the local point cloud map model to construct a rotation matrix between each lidar and the integrated navigation apparatus, wherein a sum of distances between point pairs, each pair consisting of a respective one of all points and the nearest point thereof, is taken as an error, and the rotation matrix is formed after the error is minimized; and
assigning a translation matrix to zero, and solving the rotation matrix between each lidar and the integrated navigation apparatus, thereby obtaining an initial rotation matrix of extrinsic parameter for each lidar, said initial rotation matrix characterizing the initial extrinsic parameter.

3. The method according to claim 2, wherein the step of adjusting the initial extrinsic parameter and the integrated navigation data to obtain a first-type extrinsic parameter between each lidar and the integrated navigation apparatus, as well as optimized integrated navigation data, while taking into consideration a point model on a scanned surface of real space which obeys a normal distribution, differences between lidar clock sources, and vehicle vibration comprises:
calculating a first surface-to-surface distance between two local surfaces of the real space where any two points sampled by a same lidar are located respectively;
constructing, based on the first surface-to-surface distance, the initial rotation matrix of extrinsic parameter of each lidar and the integrated navigation data, an extrinsic-parameter rough adjustment model for roughly adjusting the extrinsic parameter between each lidar and the integrated navigation apparatus, while taking into consideration the point model on the scanned surface of the real space that obeys a normal distribution;
solving the extrinsic-parameter rough adjustment model through minimum estimation, thereby obtaining an estimated rotation matrix of extrinsic parameter of each lidar;
constructing, based on the first surface-to-surface distance, the estimated rotation matrix of extrinsic parameter of each lidar and the integrated navigation data, an extrinsic-parameter adjustment model for precisely adjusting the extrinsic parameter between each lidar and the integrated navigation apparatus, while taking into consideration the differences between the lidar clock sources and the vehicle vibration; and
solving the extrinsic-parameter adjustment model through minimum estimation, in order to obtain the first-type extrinsic parameter between each lidar and the integrated navigation apparatus, as well as an optimized integrated navigation pose.

4. The method according to claim 3, wherein the step of obtaining, according to the first-type extrinsic parameter, a compensation matrix for compensating a vertical component of an extrinsic parameter between each lidar and the integrated navigation apparatus comprises:
constructing and solving a compensation matrix for aligning ground planes in the point cloud data of any two lidars according to a specified point on the surface of the real space represented in different lidar coordinate systems, wherein a preset target positioning center is taken as a reference, and the first-type extrinsic parameters of respective lidars are taken as respective degeneration extrinsic-parameters.

5. The method according to claim 4, wherein the step of obtaining a second-type extrinsic parameter between individual lidars according to the compensation matrix and the first-type extrinsic parameter of each lidar as well as the optimized integrated navigation data comprises:
calculating initial poses of each lidar at all moments, based on the optimized integrated navigation pose, and the compensation matrix and the first-type extrinsic parameter of each lidar;
calculating a second surface-to-surface distance between two local surfaces of the real space where two points respectively sampled by any two lidars at any sampling moment are located respectively, or between two points sampled by a same lidar at any two sampling moments;
constructing a pose optimization model for calculating poses of each lidar at all sampling moments based on the second surface-to-surface distance and the initial poses of each lidar;
solving the pose optimization model through iterative computations to obtain poses of lidars at all moments; and
calculating an extrinsic parameter of each lidar with respect to a main lidar based on the poses of respective lidars at all moments, thereby obtaining the second-type extrinsic parameter between individual lidars.

6. The method according to claim 5, wherein the local point cloud map model is expressed as follows:
$${𝕄}_{{L}_{i}} = \{ {}^{W} {p}_{{t}_{j}}^{k} = {}_{G}^{W} {T}_{{t}_{j}} {}_{{L}_{i}}^{G} {T}^{{L}_{i}} {p}_{{t}_{j}}^{k} \vert {}^{{L}_{i}} {p}_{{t}_{j}}^{k} ∈ {}^{{L}_{i}} {ℙ}_{{t}_{j}} , {t}_{j} ∈ {𝒯}_{{L}_{i}} \} ,$$
wherein [symbol] _{L}_{ᵢ} denotes the local point cloud map model, ^{L}^{ᵢ} [symbol] ₜ_{ⱼ} denotes the raw point cloud data scanned by lidar Lᵢ, [symbol] denotes a collection of time corresponding to all points, ^{L}^{ᵢ}pₜ_{ⱼ}^{k} denotes a model of the k^{th} point in ^{L}^{ᵢ} [symbol] ₜ_{ⱼ}, ^{W}pₜ_{ⱼ}^{k} denotes ^{L}^{ᵢ}pₜ_{ⱼ}^{k} represented in world coordinate system, _{G}^{W}Tₜ_{ⱼ} denotes a pose of a positioning center of the integrated navigation apparatus of a vehicle at a sampling moment tⱼ, and _{L}_{ᵢ}^{G}T denotes the first-type extrinsic parameter between the lidar Lᵢ and the integrated navigation apparatus; and
the rotation matrix is expressed as follows:
$${}_{{L}_{i}}^{G} {R}_{init} = arg {min}_{{{}_{{L}_{i}}^{G} R}^{}} ( kNNError ( {𝕄}_{{L}_{i}} ) ) ,$$
wherein _{L}_{ᵢ}^{G}Rᵢₙᵢₜ denotes the rotation matrix between the lidar Lᵢ and the integrated navigation apparatus, and kNNError( ) denotes error based on map calculation.

7. The method according to claim 3, wherein the first surface-to-surface distance is calculated as follows:
$$\begin{matrix}{}^{{L}_{i}} {d}_{{t}_{i} {t}_{j}}^{kl} = {}_{G}^{W} {T}_{{t}_{i}} {}_{{L}_{i}}^{G} {T}^{{L}_{i}} {p}_{{t}_{i}}^{k} - {}_{G}^{W} {T}_{{t}_{j}} {}_{{L}_{i}}^{G} {T}^{{L}_{i}} {p}_{{t}_{j}}^{k} \\ = {}_{{L}_{i}}^{W} {T}_{{t}_{i}} {}^{{L}_{i}} {p}_{{t}_{i}}^{k} - {}_{{L}_{i}}^{W} {T}_{{t}_{j}} {}^{{L}_{i}} {p}_{{t}_{i}}^{l}\end{matrix} ,$$
wherein ^{L}^{ᵢ}dₜ_{ᵢ}ₜ_{ⱼ}^{kl} denotes the first surface-to-surface distance between a local surface where the k^{th} point sampled by lidar Lᵢ at a moment tᵢ is located and a local surface where the l^{th} point sampled thereby at a moment tⱼ is located, _{L}_{ᵢ}^{G}T denotes the first-type extrinsic parameter between the lidar Lᵢ and the integrated navigation apparatus, _{G}^{W}Tₜ_{ᵢ} and _{G}^{W}Tₜ_{ⱼ} denote poses of a positioning center of the integrated navigation apparatus of a vehicle at moments tᵢ and tⱼ, respectively, ^{L}^{ᵢ}pₜ_{ᵢ}^{k} and ^{L}^{ᵢ}pₜ_{ⱼ}^{l} denote a model of the k^{th} point sampled by the lidar Lᵢ and a model of the l^{th} point sampled thereby at the moment tⱼ, respectively, and _{L}_{ᵢ}^{W}Tₜ_{ᵢ} and _{L}_{ᵢ}^{W}Tₜ_{ⱼ} denote poses of the lidar Lᵢ at the moments tᵢ and tⱼ, respectively;
the extrinsic-parameter rough adjustment model is expressed as follows:
$${}_{{L}_{i}}^{G} T = arg {min}_{{}_{{L}_{i}}^{G} T} ( {\sum }_{{t}_{i} , {t}_{j}} {\sum }_{k , l} ρ ( {‖ {}^{{L}_{i}} {d}_{{t}_{i} {t}_{j}}^{k l} ‖}_{{\sum }_{{t}_{i} {t}_{j}}^{kl}}^{2} ) + {‖ Log ( {}_{{L}_{i}}^{G} {R}^{- 1} {( {}_{{L}_{i}}^{G} R )}_{prior} ) ‖}_{{\sum }_{R}}^{2} ) ,$$
wherein _{L}_{ᵢ}^{G}T denotes the extrinsic-parameter rough adjustment model of the lidar Lᵢ, ρ( ) denotes a robust kernel function, Σₜ_{ᵢ}ₜ_{ⱼ}^{kl} denotes a covariance matrix of a first residual block, (_{L}_{ᵢ}^{G}R)ₚᵣᵢₒᵣ denotes the initial rotation matrix of extrinsic parameter between the lidar Lᵢ and the integrated navigation apparatus, _{L}_{ᵢ}^{G}R⁻¹ denotes the estimated rotation matrix of extrinsic parameter between the lidar Lᵢ to be estimated and the integrated navigation apparatus, Log( ) denotes a symbol that directly maps SO(3) space to [symbol] ³ vector space, and Σ_{R} denotes a covariance matrix of a second residual block; and
the extrinsic-parameter adjustment model is expressed as follows:
$${}_{{L}_{i}}^{G} T = arg {min}_{{𝕋}_{G} {,}_{{L}_{i}}^{G} T} ( {\sum }_{{t}_{i} , {t}_{j}} {\sum }_{k , l} ρ ( {‖ {}^{{L}_{i}} {d}_{{t}_{i} {t}_{j}}^{k l} ‖}_{{\sum }_{{t}_{i} {t}_{j}}^{kl}}^{2} ) + {\sum }_{{t}_{i}} {‖ Log ( {}_{G}^{W} {T}_{{t}_{i}}^{- 1} {( {}_{G}^{W} {T}_{{t}_{i}} )}_{prior} ) ‖}_{{\sum }_{T}}^{2} + {‖ {Log}^{′} ( {}_{{L}_{i}}^{G} {T}^{- 1} {( {}_{{L}_{i}}^{G} T )}_{prior} ) ‖}_{{\sum }_{T}}^{2} ) ,$$
wherein _{L}_{ᵢ}^{G}T denotes the extrinsic-parameter adjustment model of the lidar Lᵢ, Σₜ_{ᵢ}ₜ_{ⱼ}^{kl} denotes the covariance matrix of the first residual block, (_{G}^{W}Tₜ_{ᵢ})ₚᵣᵢₒᵣ denotes the integrated navigation data measured in real time by the integrated navigation apparatus, _{G}^{W}Tₜ_{ᵢ}⁻¹ denotes the optimized integrated navigation pose to be estimated, Σ_{T} denotes the covariance matrix of the second and third residual blocks, (_{L}_{ᵢ}^{G}T)ₚᵣᵢₒᵣ denotes the estimated rotation matrix of extrinsic parameter of the lidar Lᵢ after rough adjustment, _{L}_{ᵢ}^{G}T⁻¹ denotes the first-type extrinsic parameter of the lidar Lᵢ to be estimated, and Log′ ( ) denotes the symbol that directly maps the SE(3) space to the [symbol] ⁶ vector space.

8. The method according to claim 4, wherein the compensation matrix is expressed as follows:
$${}_{{L}_{i}}^{{G}_{i}} {T}^{{L}_{i}} p = {}_{{G}_{j}}^{{G}_{i}} {T}_{{L}_{j}}^{{G}_{j}} {T}^{{L}_{j}} p ,$$
wherein _{L}_{ᵢ}^{G}^{ᵢ}T and _{L}_{ⱼ}^{G}^{ⱼ}T denote the first-type extrinsic parameters, as degeneration extrinsic-parameters, of lidars Lᵢ and Lⱼ, respectively, _{G}_{ⱼ}^{G}^{ᵢ}T denotes the compensation matrix, ^{L}^{ᵢ}p and ^{L}^{ⱼ}p denote a same specified point on the surface of the real space represented in coordinate systems {Lᵢ} and {Lⱼ}, respectively; and
solving the compensation matrix comprises steps of:
transforming the compensation matrix as a point-cloud registration expression, and then decomposing each parameter in the compensation matrix into a coordinate rotation matrix parameter and a coordinate translation matrix parameter, in order to calculate corresponding coordinate rotation matrix and coordinate translation matrix by extracting a ground plane in the point cloud data of two lidars;
the point-cloud registration expression is as follows:
$${}^{{G}_{i}} p = {}_{{G}_{j}}^{{G}_{i}} {R}^{{G}_{j}} p + {}_{{G}_{j}}^{{G}_{i}} t$$
wherein ^{G}^{ᵢ}p denotes a specified point on the surface of the real space in lidar coordinate system {Gᵢ}, _{G}_{ⱼ}^{G}^{ᵢ}R denotes the coordinate rotation matrix of the specified point on the surface of the real space from lidar coordinate systems {Gⱼ} to {Gᵢ}, ^{G}^{ⱼ}p denotes the specified point on the surface of the real space in the lidar coordinate system {Gⱼ}, and _{G}_{ⱼ}^{G}^{ᵢ}t denotes the coordinate translation matrix of the specified point on the surface of the real space from the lidar coordinate systems {Gⱼ} to {Gᵢ}; and
the coordinate rotation matrix and the coordinate translation matrix are expressed as follows:
$$\{ \begin{matrix}u = \frac{{n}_{1} \times {n}_{2}}{‖ {n}_{1} \times {n}_{2} ‖} \\ θ = arc cos ( {n}_{1} \cdot {n}_{2} ) \\ R = I + {[ u ]}_{\times } sin θ + {[ u ]}_{\times }^{2} ( 1 - cos θ ) \\ t = {[ 0 , 0 , {d}_{1} - {d}_{2} ]}^{T}\end{matrix} ,$$
wherein [n₁^{T}, d₁] and [n₂^{T}, d₂] denote parameters of the ground planes where the specified point on the surface of the real space is located represented in the lidar coordinate systems {Gᵢ} and {Gⱼ}, respectively, n₁ and n₂ denote normal vectors of two ground planes respectively, d₁ and d₁ denote intercepts of the two ground planes respectively, u denotes a unit vector orthogonal to both n₁ and n₂, θ denotes an angle between n₁ and n₂, R denotes the coordinate rotation matrix, t denotes the coordinate translation matrix, I denotes identity matrix, and T denotes transposition symbol.

9. The method according to claim 5, wherein the initial pose of each lidar is calculated as follows:
$${( {𝕋}_{L} )}_{init} = \{ {}_{{L}_{m}}^{W} {T}_{{t}_{i}} = {}_{{G}_{0}}^{W} {T}_{{t}_{i}} {}_{{G}_{m}}^{{G}_{0}} {T}_{{L}_{m}}^{{G}_{m}} T \vert {}_{{G}_{0}}^{W} T ∈ {𝕋}_{G} , {}_{{L}_{m}}^{{G}_{m}} T ∈ {𝕋}_{c} , {}_{{L}_{m}}^{{G}_{m}} T ∈ {𝔼}_{G} , {L}_{m} ∈ 𝕃 , {t}_{i} ∈ {𝒯}_{{L}_{m}} \} ,$$
wherein ( [symbol] _{L})ᵢₙᵢₜ denotes initial poses of all lidars, _{L}_{ₘ}^{W}Tₜ_{ᵢ} denotes the initial pose of lidar Lₘ at moment tᵢ, G₀ denotes the target positioning center, _{G}_{₀}^{W}Tₜ_{ᵢ} denotes the optimized integrated navigation pose at the moment tᵢ, _{G}_{ₘ}^{G}^{₀}T denotes the compensation matrix of the lidar Lₘ, _{L}_{ₘ}^{G}^{ₘ}T denotes a matrix of the first-type extrinsic parameter of the lidar Lₘ, [symbol] _{G} denotes a set of poses of the optimized integrated navigation apparatus, [symbol] _{c} denotes a set of the compensation matrix, [symbol] _{G} denotes a set of the first-type extrinsic parameters between the lidars and the integrated navigation apparatus, [symbol] denotes a set of the lidars, and [symbol] denotes a set of time;
the second surface-to-surface distance is calculated as follows:
$${( {d}_{{t}_{i} {t}_{j}}^{k l} )}_{mn} = {}_{{L}_{m}}^{W} {T}_{{t}_{i}} {}^{{L}_{m}} {p}_{{t}_{i}}^{k} - {}_{{L}_{n}}^{W} {T}_{{t}_{j}} {}^{{L}_{n}} {p}_{{t}_{j}}^{l}$$
wherein (dₜ_{ᵢ}ₜ_{ⱼ}^{kl})ₘₙ denotes the second surface-to-surface distance between the local surface where the k^{th} point sampled by the lidar Lₘ at the moment tᵢ is located and the local surface where the l^{th} point sampled by lidar Lₙ at moment tⱼ is located, _{L}_{ₘ}^{W}Tₜ_{ᵢ} denotes the initial poses of the lidar Lₘ at the moment tᵢ, Lₙ^{W}Tₜ_{ⱼ} denotes the initial poses of the lidar Lₙ at the moment tᵢ, ^{L}^{ₘ}pₜ_{ᵢ}^{k} and ^{L}^{ₙ}pₜ_{ⱼ}^{l} denote the k^{th} point sampled by the lidar Lₘ at the moment tᵢ and the l^{th} point sampled by the lidar Lₙ at the moment tᵢ, respectively;
the pose optimization model is expressed as follows:
$${𝕋}_{L} = arg {min}_{{𝕋}_{L}} ( {\sum }_{m , n} {\sum }_{{t}_{i} , {t}_{j}} {\sum }_{k , l} ρ ( {‖ {( {d}_{{t}_{i} {t}_{j}}^{k l} )}_{mn} ‖}_{{( {\sum }_{{t}_{i} {t}_{j}}^{kl} )}_{mn}}^{2} ) + {‖ {Log}^{′} ( {}_{{L}_{0}}^{W} {T}_{{t}_{0}}^{- 1} {( T )}_{identity} ) ‖}_{{\sum }_{T}}^{2} ) ,$$
wherein (Σₜ_{ᵢ}ₜ_{ⱼ}^{kl})ₘₙ denotes a covariance matrix of a first residual block, _{L}_{₀}^{W}Tₜ_{₀} denotes the pose of lidar L₀ to be estimated at a moment t₀, (T)_{identity} denotes an identity matrix formed by the initial poses of the lidar L₀, Σ_{T} denotes a covariance matrix of a second residual block, and Log′ ( ) denotes a symbol that directly maps SE(3) space to [symbol] ⁶ vector space; and
the second-type extrinsic parameter between individual lidars is calculated as follows:
$${}_{{L}_{m}}^{{L}_{0}} T = Exp ( \frac{1}{\vert {𝒯}_{sync} \vert} {\sum }_{{t}_{i}} {Log}^{′} ( {( {}_{{L}_{0}}^{W} {T}_{{t}_{i}} )}^{- 1} {}_{{L}_{m}}^{W} {T}_{{t}_{i}} ) ) ,$$
wherein _{L}_{ₘ}^{L}^{₀}T∈ [symbol] _{G} denotes the second-type extrinsic parameter between lidars L₀ and Lₘ, _{L}_{₀}^{W}Tₜ_{ᵢ} denotes an estimated pose of the lidar L₀ at the moment tᵢ, Lₘ^{W}Tₜ_{ᵢ} denotes a pose of the lidar Lₘ to be estimated at the moment tᵢ, Exp( ) denotes a symbol that directly maps the [symbol] ⁶ vector space to the SE(3) space, Log′ ( ) denotes the symbol that directly maps the SE(3) space to the [symbol] ⁶ vector space, and [symbol] denotes a set of timestamps that have been synchronized.

10. The method according to claim 5, wherein prior to calculating the second-type extrinsic parameter between individual lidars, the method further comprises a step of:
removing anomalous poses from poses of respective lidars at all moments based on 3σ principle.

11. A computer-readable storage medium, comprising a series of instructions for performing steps in the method of calibration for multi-lidar and integrated-navigation according to claim 1.

12. A system of calibration for multi-lidar and integrated-navigation, comprising:
an initialization module, configured to obtain raw point cloud data from multiple lidars and integrated navigation data from an integrated navigation apparatus, and calculate an initial extrinsic parameter characterizing a conversion relationship between each lidar and the integrated navigation data;
a first-type extrinsic-parameter calibration module, configured to adjust the initial extrinsic parameter and the integrated navigation data, taking into account factors including a point model on a scanned surface of real space which obeys a normal distribution, differences between lidar clock sources and vehicle vibration, thus obtaining a first-type extrinsic parameter between each lidar and the integrated navigation apparatus, as well as optimized integrated navigation data;
a ground alignment module, configured to obtain, based on the first-type extrinsic parameter, a compensation matrix for compensating a vertical component of an extrinsic parameter between each lidar and the integrated navigation apparatus; and
a second-type extrinsic-parameter calibration module, configured to obtain a second-type extrinsic parameter between individual lidars based on the compensation matrix and the first-type extrinsic parameter of each lidar as well as the optimized integrated navigation data.
